(19) United States
(12) Patent Application Publication
(10) Pub. No.: US 2011/0267367 A1
(43) Pub. Date: Nov. 3, 2011

(54) HANDHELD ELECTRIC APPARATUS AND GRAPHIC INTERFACE OPERATION METHOD

(75) Inventors: CHIEH-CHIH TSAI, Taipei County (TW); YU-MAO FENG, Taipei County (TW)

(73) Assignee: ACER INCORPORATED, Taipei County (TW)

(21) Appl. No.: 12/770,718

(22) Filed: Apr. 30, 2010

(51) Int. Cl. G09G 5/00; G06F 3/048; G06F 15/16

(52) U.S. Cl. 345/629; 709/203; 715/840

(57) ABSTRACT

A handheld electric apparatus and graphic interface operation method thereof are disclosed. In embodiment, the handheld electric apparatus comprises a display unit, a button unit, a storage unit and a processor. The storage unit stores an application and a widget. The processor is operable to execute the application and display the execution image of the application on the display unit in full screen. When the button unit is triggered, the processor is operable to execute the widget and overlaying the execution image of the widget on the execution image of the application. The processor keeps the execution of the application while the widget is executed. Therefore, the operation convenience of handheld electric apparatus can be improved.

### TECHNICAL FIELD

The present invention relates generally to a handheld electric apparatus and graphic interface operation method thereof, more particularly, related to the widget displayed and overlaid on the full-screen execution image of application of the handheld electric apparatus.

### BACKGROUND

As portable electronic devices become more compact, and the number of functions performed by a given device increase, it has become a significant challenge to design a user interface that allows users to easily interact with a multifunction device. This challenge is particular significant for handheld portable devices, which have much smaller screens than desktop or laptop computers. This situation is unfortunate because the user interface is the gateway through which users receive not only content but also responses to user actions or behaviors, including user attempts to access a device's features, tools, and functions. Some portable communication devices (e.g., mobile telephones, sometimes called mobile phones, cell phones, cellular telephones, and the like) have resorted to adding more pushbuttons, increasing the density of push buttons, overloading the functions of pushbuttons, or using complex menu systems to allow a user to access, store and manipulate data. These conventional user interfaces often result in complicated key sequences and menu hierarchies that must be memorized by the user.

The widget is a popular graphical user interface on handheld electric apparatus, which comprises information display component to make user to view updated information quickly. Because of small size of screen of handheld electric apparatus, the execution image of running application is usually displayed in full screen. When user desires to view the content of widget, he/she must close the running application first and then open the widget, and reopen the application after closing the widget, it causes inconvenience and time cost for user. Accordingly, there is a need for handheld electric apparatus with more transparent and intuitive graphic interface operation flow between widget and application, that is easy to use, configure, and/or adapt. Such graphic interface operation flow increases the effectiveness, efficiency and user satisfaction with handheld electric apparatus.

### SUMMARY OF THE INVENTION

Therefore, an object of the present invention is to provide a handheld electric apparatus and graphic interface operation method thereof, so as to improve the operation convenience of handheld electric apparatus.

The object of the present invention can be achieved by providing a handheld electric apparatus which comprises a display unit, a button unit, a storage unit and a processor. The storage unit stores an application and a widget. The processor is operable to execute the application and display the execution image of the application on the display unit in full screen. When the button unit is triggered, the processor is operable to execute the widget and overlaying the execution image of the widget on the execution image of the application. The processor keeps the execution of the application while the widget is executed.

Preferably, the execution image of the widget is displayed semi-transparently on the displayed unit.

Preferably, the processor continues executing the application after the widget is stopped.

Preferably, the widget comprises an information display component.

Preferably, the information display component is updated while the processor executes the widget.

Preferably, the handheld electric apparatus further comprises a network connecting unit, and the processor receives an update data for the information display component from a network through the network connecting unit.

Preferably, the handheld electric apparatus further comprises a control interface unit which allows user to set the information display component.

The object of the present invention can be achieved by providing a graphic interface operation method applied on a hand held electric apparatus. The graphic interface operation method comprises steps of executing an application on the hand held electric apparatus, and displaying the execution image of the application in full screen on a display unit of the hand held electric apparatus; providing a button unit on the hand held electric apparatus; when the button unit is triggered, executing a widget and overlaying execution image of the widget on the execution image of the application; keeping the execution of the application while the widget is executed.

Preferably, the graphic interface operation method further comprises a step of semi-transparently displaying the execution image of the widget.

Preferably, the graphic interface operation method further comprises a step of continuing executing the application after the widget is stopped.

Preferably, the widget comprises an information display component.

Preferably, the graphic interface operation method further comprises a step of receiving an update data for the information display component through from a network.

Preferably, the widget comprises a return component, and user can trigger this return component to close the widget.

### BRIEF DESCRIPTION OF THE DRAWINGS

The accompanying drawings, which are included to provide a further understanding of the invention, illustrate embodiments of the invention and together with the description serve to explain the principle of the invention.

FIG. 1 illustrates a block diagram of an exemplary handheld electric apparatus in accordance with the present invention;

FIG. 2 illustrates an exemplary schematic view of operation of the handheld electric apparatus in accordance with the present invention;

FIG. 3 illustrates another exemplary schematic view of operation of the handheld electric apparatus in accordance with the present invention;

FIG. 4 illustrates another exemplary schematic view of operation of the handheld electric apparatus in accordance with the present invention;

FIG. 5 illustrates a first exemplary flow chart of graphic interface operation method in accordance with the present invention; and

FIG. 6 illustrates a second exemplary flow chart of graphic interface operation method in accordance with the present invention.

### DETAILED DESCRIPTION OF THE PREFERRED EMBODIMENTS

The invention and its various embodiments can now be better understood by turning to the following detailed description of the preferred embodiments, which are presented as illustrated examples of the invention defined in the claims. It is expressly understood that the invention as defined by the claims may be broader than the illustrated embodiments described below. It should also be noted that the drawings are in simplified form and are not to precise scale.

In reference to the disclosure herein, for purposes of convenience and clarity only, directional terms, such as, top, bottom, left, right, up, down, over, above, below, beneath, rear, front, distal, and proximal are used with respect to the accompanying drawings. Such directional terms should not be construed to limit the scope of the invention in any manner.

In one preferred aspect of the inventive subject matter, the projection system provides a color visual output, wherein the color vividness and performance of the visual output is enhanced. The contemplated color visual output can include still images and video images.

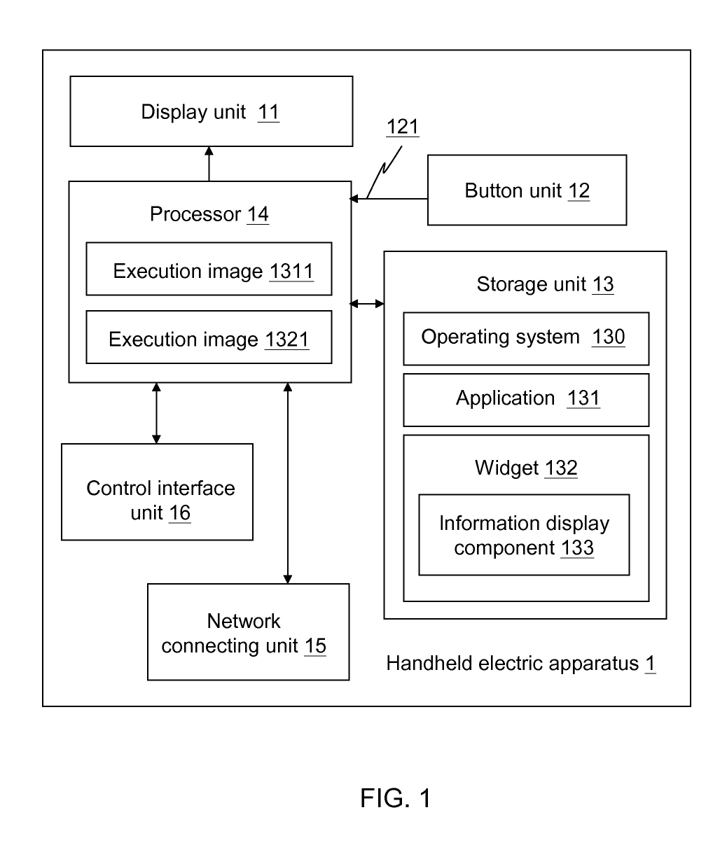

FIG. 1 illustrates a block diagram of an exemplary handheld electric apparatus in accordance with the present invention. The handheld electric apparatus 1 comprises a display unit 11, a button unit 12, a storage unit 13, a processor 14, a network connecting unit 15 and a control interface unit 16. The processor 14 is electrically coupled to the display unit 11, the button unit 12, the storage unit 13, the network connecting unit 15 and the control interface unit 16. The display unit 11 is capable of displaying text or image. Preferably, the display unit 11 can be a LED panel or an OLED panel. The control interface unit 16, such as touch control module, is capable of allowing user to operate the handheld electric apparatus 1. The storage unit 13 is used to store an operating system 130, an application 131 and a widget 132 which are executable for the processor 14. User can operate the control interface unit 16 to set at least one information display component 133 in the widget 132. For example, the information display component can be a weather information component, a time information component, a call record information component or a calendar information component. Preferably, the storage unit 13 can be an embedded memory, a ROM, a removable memory card or a flash memory. The network connecting unit 15 can be operable to link with internet by a communication protocol, so as to enable the networking function of the handheld electric apparatus 1. Preferably, the communication protocol can be a 3G protocol, WIFI protocol, WIMAX protocol or a LTE protocol. User can input a trigger signal 121 by pushing the button unit 12, such as a physical button, a virtual button icon or a touch control button.

By executing the operating system 130 accessed from storage unit 13, the processor 14 can control the hardware and soft resource of the handheld electric apparatus 1 through the running operating system 130, so that the basic functionality of handheld electric apparatus 1 can be activated. For example, while user needs a location search function, he/she can control the processor 14 via the control interface unit 16 to execute a corresponding application 131, such as map search application, and the operating system 130 then allocates memory area and in/out port to enable execution of the map search application. The execution image 1311 of the running application 131 is displayed on the display unit 11 in full screen. When the map search application is running and the user desires to check the information of the widget 132, he/she can activate the button unit 12. Upon receipt of the trigger signal 121 from the button unit 12, the processor 14 accesses the widget 132 from the storage unit 13 and executed it. The execution image 1321 of running widget 132 is displayed and overlaid on the execution image 1311. It is noted that the processor 14 still keeps the execution of the application 131 while the widget 132 is executed.

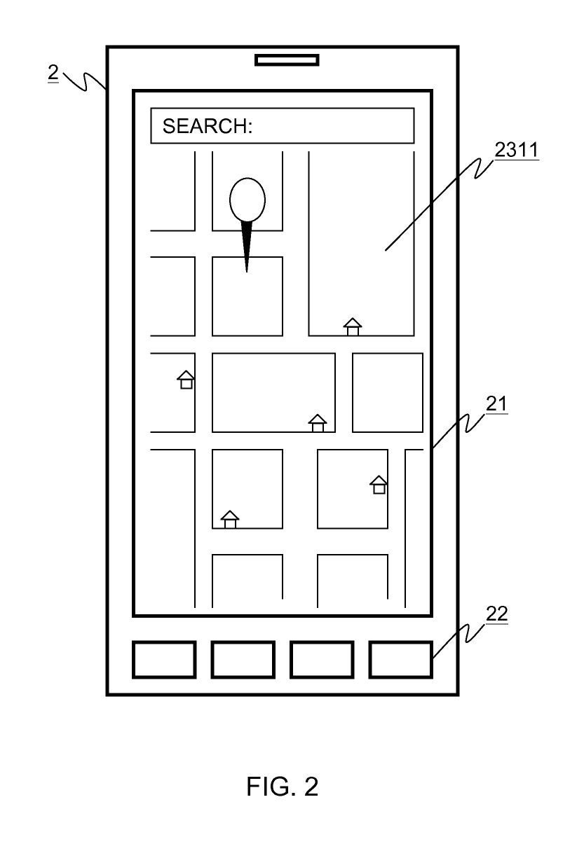

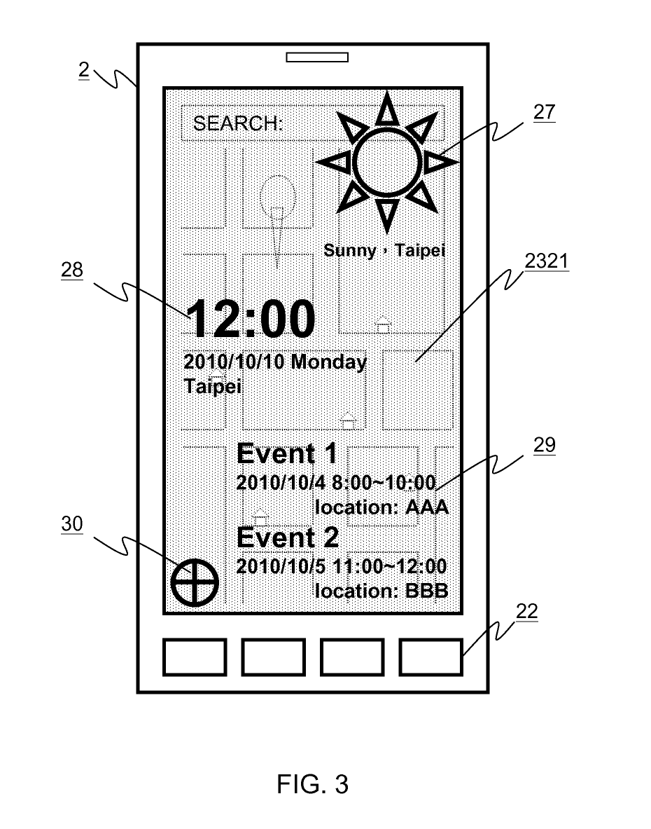

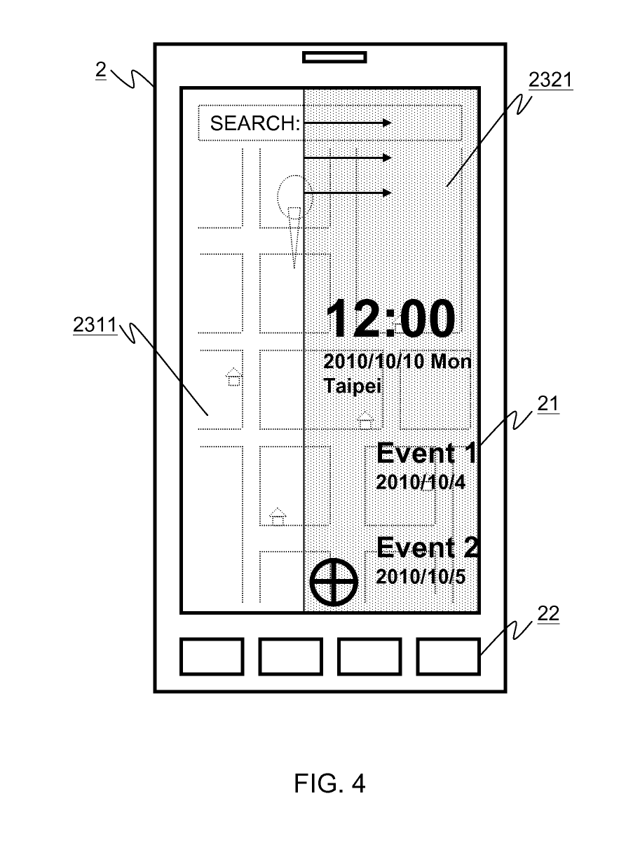

FIG. 2, FIG. 3 and FIG. 4 illustrate exemplary schematic views of operation of the handheld electric apparatus in accordance with the present invention. For explanation, a smart phone 2 as an embodiment of the handheld electric apparatus in accordance with the present invention, comprises a touch screen 21 and multiple buttons 22 disposed on its outward appearance. For user, the widgets installed in the smart phone 2 can simply the operation flow of usual functions without activating multiple web browsers or applications step by step. Without widget, user must manually activate browser to link w web site for obtaining real-time weather information, and activate calendar application to check schedule sequentially. In the other hand, if user set a weather information component and a calendar notice component in the widget in advance and he/she can check real-time weather information and schedule at the same time by just activating the widget. Preferably, while executing the widget, the processor 14 will link to internet for collecting weather information and access said schedule information from database of calendar application in background.

FIG. 2 illustrates an execution image 2311 of a map search application being executed in the smart phone 2 and the execution image 2311 is displayed on the touch screen 21. During the operation of the map search application, user may want to check the information set on the widget, for example, he/she wants to check the event location recorded on the calendar for further location search on the map. In prior art, user must close the map search application first and then open the widget for checking event location, and reopen the map search application to search the event location after closing the widget, it causes inconvenience and time cost for user. For such situation, user just pushes the button 22 of the smart phone 2, and the processor 14 then executes the widget upon the receipt of the trigger signal 121 from the button 22 to generate an execution image 2321 of the widget, and overlays the execution image 2321 on the execution image 2311 by a semi-transparently display manner, as shown in FIG. 3. The execution image 2321 shown in FIG. 3 is drawn in dotted pattern for representing the semi-transparent effect. In this embodiment, the information display components set in the widget comprise a return component 30, a weather information component 28 and a calendar notice component 29. Therefore, user can review all desired information through the widget, without closing the map search application, or switching windows of applications.

Preferably, the information display component can be updated via data distributed on internet. When invoking the widget, the processor of the smart phone 2 can update information display component at the same time. For example, if user has modified the calendar, date or time of the smart phone 2, the processor can update the schedule data of calendar notice component, or time date of the time information component 28; or the processor can connect with the internet to obtain the real-time weather data which is used to update weather information component 27. User can trigger the return component 30 to close the widget and remove the semi-transparently overlay of the execution image 2321 from the execution image 2311, so that he/she can view the execution image 2311 of the map search application clearly for further operation, as shown in FIG. 4. It is noted that the map search application is not closed during the execution of the widget, so user can operate the map search application after closing the widget.

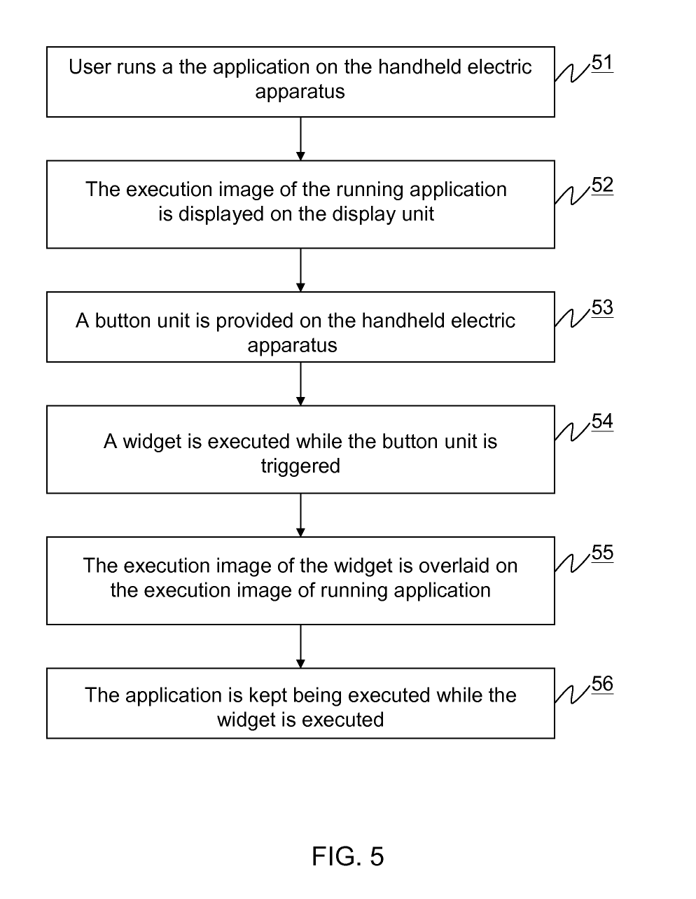

FIG. 5 illustrates a first exemplary flow chart of graphic interface operation method in accordance with the present invention. In step 51, user runs a the application on the handheld electric apparatus, and in step 52 the execution image of the running application is displayed on the display unit of the handheld electric apparatus in full screen mode, such as the execution image 2311 of map search application shown in FIG. 2. In step 53, a button unit is provided on the handheld electric apparatus. Preferably, The button unit can be a physical button, a virtual button icon or a touch control button. In step 54 a widget is executed while the button unit is triggered. As shown in FIG. 2, user can push the button 22 to view the content of widget during operation of map search application. In step 55 the execution image of the widget is overlaid on the execution image of running application. In step 56, the application is kept being executed while the widget is executed.

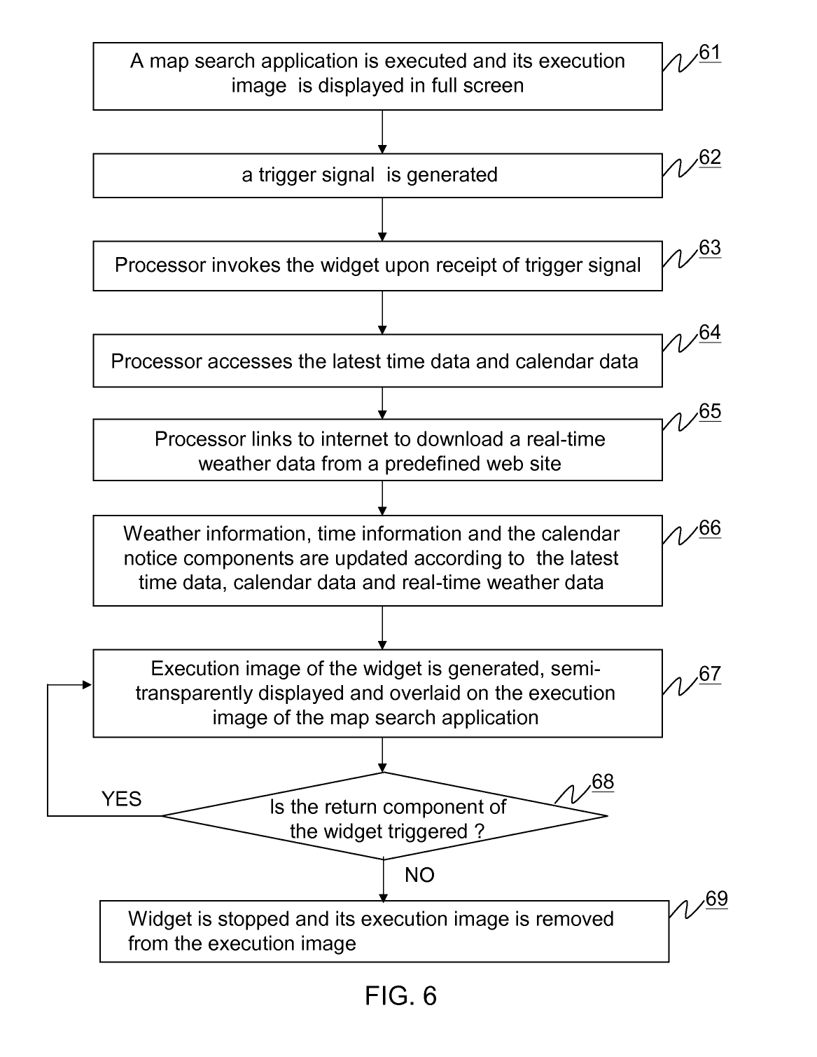

In FIG. 6 illustrates a second exemplary flow chart of graphic interface operation method in accordance with the present invention. The second exemplary flow chart corresponds to the smart phone 2 shown in FIG. 2, FIG. 3 and FIG. 4, where user has add a weather information component, a time information component and a calendar notice component into the widget of the smart phone 2. In step 61, a map search application is executed by the processor of the smart phone 2, and the execution image 2311 of the map search application is displayed on the touch screen 21 in full screen, as shown in FIG. 2. While user wants to view weather information, time information or schedule information, he/she can push button 22 to generate a trigger signal in step 62. In step 63, the processor invokes the widget upon receipt of trigger signal, and the map search application is kept being executed. In step 64, the processor accesses the latest time data and calendar data from memory of the smart phone 2. In step 65, the processor links to internet to download a real-time weather data from a predefined web site. In step 66, the weather information component, time information component and the calendar notice component are updated according to the latest time data, calendar data and the real-time weather data.

In step 67 the execution image 2321 of the widget is generated, semi-transparently displayed and overlaid on the execution image 2311 of the map search application, as shown in FIG. 3. The weather information component, time information component and calendar notice component are visually shown on the execution image 2321. Preferably, the contents of these components can be shown as icons for user's reading. For example, a sun icon can be used in weather information component to indicate the sunny weather. In step 68, it is determined whether the return component of the widget is triggered or not. If the return component of the widget is not triggered yet, the flow goes to the step 67; otherwise, if the return component of the widget is triggered, in step 69 the widget is stopped and the execution image 2321 is removed from the execution image 2311, so that user can view the execution image 231 clearly for continuing to operate the map search application.

Thus, specific embodiments and applications of handheld electric apparatus and graphic interface operation method thereof have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements. The claims are thus to be understood to include what is specifically illustrated and described above, what is conceptually equivalent, what can be obviously substituted and also what essentially incorporates the essential idea of the invention. In addition, where the specification and claims refer to at least one of something selected from the group consisting of A, B, C . . . and N, the text should be interpreted as requiring only one element from the group, not A plus N, or B plus N, etc.

What is claimed is:

1. A handheld electric apparatus, comprising:
a display unit;
a button unit;
a storage unit capable of storing an application and a widget; and
a processor capable of executing said application and displaying the execution image of said application on said display unit in full screen; and when said button unit is triggered, said processor executing said widget and overlaying the execution image of said widget on the execution image of said application;
wherein said processor keeps the execution of said application while said widget is executed.

2. The handheld electric apparatus of claim 1, wherein said execution image of said widget is displayed semi-transparently on said displayed unit.

3. The handheld electric apparatus of claim 1, wherein said processor continues executing said application after said widget is stopped.

4. The handheld electric apparatus of claim 1, wherein said widget comprises an information display component.

5. The handheld electric apparatus of claim 4, wherein said information display component is updated while said processor executes said widget.

6. The handheld electric apparatus of claim 5, further comprising a network connecting unit, and said processor receives an update data for said information display component from a network through said network connecting unit.

7. The handheld electric apparatus of claim 4, further comprising a control interface unit which allows user to set said information display component.

8. The handheld electric apparatus of claim 1, wherein said widget comprises a return component, and user can trigger said return component to close said widget.

9. A graphic interface operation method applied on a hand held electric apparatus, comprising steps of:
executing an application on said hand held electric apparatus, and displaying the execution image of said application in full screen on a display unit of said hand held electric apparatus;
providing a button unit on said hand held electric apparatus;
when said button unit is triggered, executing a widget and overlaying execution image of said widget on said execution image of said application; and
keeping the execution of said application while said widget is executed.

10. The graphic interface operation method of claim 9, further comprising a step of:
semi-transparently displaying said execution image of said widget.

11. The graphic interface operation method of claim 9, further comprising a step of:
continuing executing said application after said widget is stopped.

12. The graphic interface operation method of claim 9, wherein said widget comprises an information display component.

13. The graphic interface operation method of claim 12, further comprising a step of:
updating information display component while said widget is executed.

14. The graphic interface operation method of claim 13, further comprising a step of:
receiving an update data for said information display component through from a network.

15. The graphic interface operation method of claim 9, wherein said widget comprises a return component, and user can trigger said return component to close said widget.
